(19) United States
(12) Patent Application Publication
(10) Pub. No.: US 2023/0177814 A1
(43) Pub. Date: Jun. 8, 2023

(54) UNSUPERVISED DATA AUGMENTATION FOR MULTIMEDIA DETECTORS

(71) Applicant: Comcast Cable Communications, LLC, Philadelphia, PA (US)

(72) Inventor: Ehsan Younessian, Washington, DC (US)

(21) Appl. No.: 17/457,319

(22) Filed: Dec. 2, 2021

(51) Int. Cl. G06V 10/776; G06V 20/40; G06V 20/70; G06N 20/00

(52) U.S. Cl. CPC G06V 10/776; G06V 20/41; G06V 20/70; G06N 20/00; G06V 2201/10

(57) ABSTRACT

Training data associated with detection of objects within a content asset may be generated in an automated manner. A content asset, such as video content, may be associated with metadata. A relevance score indicating a likelihood of the content asset comprising at least one object may be determined based on the metadata. A portion of the content asset may be identified as containing an instance of the object. The identified portion of the content asset may be a false identification if the relevance score for the content asset fails to satisfy a threshold value, or a positive identification if it satisfies the threshold value. The results, e.g., negative training data if the identified portion of the content asset is a false identification, may be used as negative training data for a multimedia detector that is based on a machine learning model.

### BACKGROUND

Multimedia detectors, such as object detectors, audio event detectors, semantic concept (e.g., violence, emotion, etc.) detectors, need substantial amounts of augmented (e.g., labeled) data for training.” Labeled training data may be gathered from public platforms or may be manually generated. However, training data gathered from public platforms may be insufficient to train a multimedia detector. For example, public platforms may not provide enough data to sufficiently train the multimedia detector, or the training data gathered from public platforms may be of a low-quality. Manually generating training data may be time-consuming or expensive. In addition to being time-consuming and expensive, manual generation of training data is also subject to human error. Therefore, improvements in data augmentation for multimedia detectors are needed.

### SUMMARY

Methods and systems are disclosed herein for data augmentation for multimedia detectors. Augmented data may be generated in an unsupervised manner, and the data may be used as training data for a multimedia detector and/or for immediate services. In one example, a relevance score indicative of a likelihood of a content asset comprising at least one instance of an object may be determined. The determination may be made, at least in part, based on metadata associated with the content asset. The content asset may be input to a multimedia detector, and the multimedia detector may detect a portion of the content asset and identify the portion as an instance of the object. If the relevance score does not satisfy a threshold, it may be determined, based on the relevance score, that the detected portion of the content asset is not an instance of the object. The detected portion of the content asset may then be labeled as a false identification of the object. This labeled portion of the content asset may be used as negative training data for a machine learning model or for immediate services.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to features that solve any or all disadvantages noted in any part of this disclosure.

### BRIEF DESCRIPTION OF THE DRAWINGS

The following detailed description is better understood when read in conjunction with the appended drawings. For the purposes of illustration, examples are shown in the drawings; however, the subject matter is not limited to specific elements and instrumentalities disclosed. In the drawings:

FIG. 1 shows an example communications network;

FIG. 2 shows a set of exemplary metadata associated with a content asset

FIG. 3 shows another set of exemplary metadata associated with a content asset;

FIG. 4 shows a method for generating training data;

FIG. 5 shows an example device.

### DETAILED DESCRIPTION OF ILLUSTRATIVE EMBODIMENTS

A multimedia detector may be trained to detect one or more objects or items of interest in a content asset, such as linear content, non-linear content, video content, audio content, multi-media content, recorded content, stored content, or any other form of content a user may wish to view, hear or otherwise consume. For example, multimedia detectors may be trained to detect objects of interest in video content, such as television programs or movies. Such objects of interest may include a sound, such as a gunshot noise, an audio event, a tangible item, a particular character, a location, or a concept, such as violence or emotion. A distributor of content may use a multimedia detector to detect objects of interest in the content that it distributes. By learning about certain objects of interest in the content that it distributes, the content distributor may be able to better tailor content for different markets or for different consumers. For example, the content distributor may be able to better recommend content for a particular consumer or the content distributor may be able to tailor content for a particular market in order to meet that market's compliance requirements.

A multimedia detector may be implemented using, or be based on, one or more machine learning models, such as deep learning models to detect visual (e.g. object, concept, and/or action) events and/or audio events. Machine learning models may be trained to detect the objects of interest using labeled training data. While training data may be derived using content that is available on various public platforms, such as YouTube, flicker, Instagram, or Twitter, such publicly available training data may be insufficient to accurately train the machine learning models. For example, the training data available on public platforms may not be of a sufficient quality to accurately train the machine learning models. The training data available on public platforms may come from low-quality, user-produced videos, such as YouTube videos. A content distributor that deploys a multimedia detector implemented using a machine learning model trained with publicly available training data on a professionally produced and edited video from the entertainment domain may not receive accurate detection results. Such inaccurate results may be caused by the discrepancy between the training and test data distribution and quality.

Using publicly available training data may also cause a machine learning model of multimedia detector to falsely detect objects of interest. To train a machine learning model to detect an object of interest using publicly available training data, positive training data samples may be taken from the public domain, such as from Google AudioSet. Positive training data samples may be taken from the class that most closely corresponds to the object of interest. For example, if the object of interest is a gunshot sound, positive training data samples may be taken from the Google AudioSet class “Explosions” and its subclass “Gunshot, gunfire.” However, some of these data samples may contain false identifications. For example, if the object of interest is a gunshot sound, a false identification may be any noise that sounds like a gunshot sound but is not actually a gunshot sound. These false identifications may occur if the publicly available data sample contains background music, background noise, or noises that sound like gunshot sounds, including hitting, knocking, punching, or door slamming.

Adding negative training data samples to the set of training data used to train the machine learning model may reduce the number of false identifications that occur. However, negative training data may not be readily available in the public domain and generating such negative training data may be expensive and time-consuming. For example, an individual may have to view content and manually label instances in the content as negative training data. Accordingly, it may be desirable to generate negative training data, including negative training data from the entertainment domain, in an unsupervised manner.

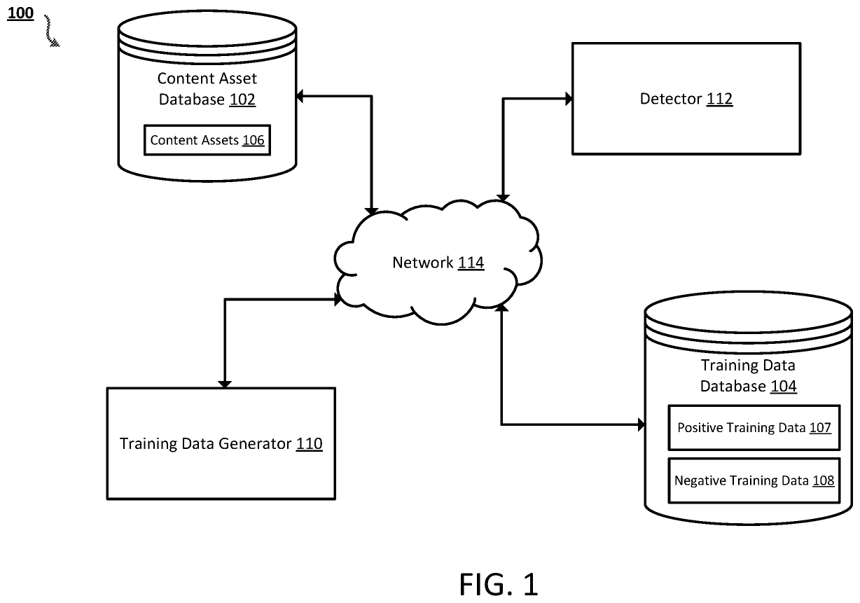

FIG. 1 illustrates an example system 100 in which the methods and apparatus described herein may be implemented. Such a system 100 may comprise a content asset database 102, a training data database 104, a training data generator 110, and a detector 112. The content asset database 102, training data database 104, training data generator 110, and detector 112 may communicate via a network 114.

The content asset database 102 may store one or more content assets, such as content assets 106. A content asset may comprise one or more of linear content, non-linear content, video content, audio content, multi-media content, recorded content, stored content, or any other form of content a user may wish to consume. Video content may refer generally to any video content produced for viewer consumption regardless of the type, format, genre, or delivery method. Video content may comprise video content produced for broadcast via over-the-air radio, cable, satellite, or the internet. Video content may comprise digital video content produced for digital video streaming or video-on-demand. Video content may comprise a movie, a television show or program, an episodic or serial television series, or a documentary series, such as a nature documentary series. As yet another example, video content may include a regularly scheduled video program series, such as a nightly news program. The content assets 106 may be associated with one or more content distributors that distribute the content assets 106 to viewers for consumption. A content asset may comprise a song, a television show, a live broadcast, a movie, a podcast, an audio book, or any other type of content a user may wish to consume. The content asset database 102 may be implemented or hosted on a computing device (not shown), such as a server. The computing device on which the content asset database is hosted may be part of a content distribution network. The content distribution network may be operated by a content provider, such as a cable television provider, a streaming service, a multichannel video programming distributor, a multiple system operator, or any other type of service provider.

The content assets 106 may each be associated with metadata. The metadata may be generated, for example, by a content distributor to which the content assets 106 belong, by the party that produced the content assets, or by an unrelated third-party. The metadata associated with a content asset 106 may describe the contents of the content asset 106 by applying a plurality of descriptive labels to all, or part, of the content asset. The plurality of descriptive labels may include at least one of a theme, subject, genre, rating, or time period associated with the content asset 106.

The content asset database 102 may be implemented in the form of a network storage, such as, for example, a cloud-based storage accessible by other systems or devices via a network, such as the network 114. In addition to the content asset(s) 106, the content asset database 102 may store other information associated with the content assets or a service provider that maintains or operates the content asset database 102. The content asset database 102 may comprise one or more computing devices and/or network devices. For example, the content asset database 102 may comprise one or more networked servers. The content asset database 102 may each comprise a data storage device and/or system, such as a network-attached storage (NAS) system.

The detector 112 may comprise a multimedia detector. The multimedia detector may comprise an object detector, an audio event detector, a semantic concept (e.g., violence, emotion, etc.) detector, or any other type of detector capable of detecting items of interest in a content asset. The detector 112 may be implement using, or be based on, one or more machine learning models. Any suitable machine learning model may be employed. For example, the detector 112 may be implemented using, or be based on, one or more deep learning models, such as convolutional neural networks (CNNs), recurrent neural networks (RNNs), long short term memory networks (LSTMs), generative adversarial networks (GANs), and/or multilayer perceptrons (MPLs).

The detector 112 may be implemented in one or more computing devices. Such a computing device may comprise one or more processors and memory storing instructions that, when executed by the one or more processors, cause the computing device to perform one or more of the various methods or techniques described here. The memory may comprise volatile memory (e.g., random access memory (RAM)) and/or non-volatile memory (e.g., a hard or solid-state drive). The memory may comprise a non-transitory computer-readable medium. The computing device may comprise one or more input devices, such as a mouse, a keyboard, or a touch interface. The computing device may comprise one or more output devices, such as a monitor or other video display. The computing device may comprise an audio input and/or output. The computing device may comprise one or more network communication interfaces, such as a wireless transceiver (e.g., Wi-Fi or cellular) or wired network interface (e.g., ethernet). The one or more network communication interfaces may be configured to connect to the network 114.

The detector 112 may comprise one or more computing devices and/or network devices. For example, the detector 112 may comprise one or more networked servers. The detector 112 may comprise a data storage device and/or system, such as a network-attached storage (NAS) system.

The network 114 may comprise a local area network, a wide area network, a wireless network, a wired network, the Internet, a combination thereof, or any other type of network over which the components of the system 100 may communicate. The network 114 may comprise one or more public networks (e.g., the Internet) and/or one or more private networks. A private network may include a wireless local area network (WLAN), a local area network (LAN), a wide area network (WAN), a cellular network, or an intranet. The network 114 may comprise wired network(s) and/or wireless network(s).

The training data database 104 may store data that can be used to train the detector 112 or one or more machine learning models on which the detector 112 is based. The training data database 104 may comprise at least one of positive training data or negative training data. If the detector 112 or the one or more machine learning models on which the detector 112 is based is being trained to classify elements of a set into two different groups, then examples from both classes may be included in the training data. Examples from the first class may be positive training examples. For example, if the detector 112 or the one or more machine learning models on which the detector 112 is based are being trained to detect whether a noise is a gunshot noise or not a gunshot noise, examples of noises that are gunshot noises may be positive training examples. However, if the detector 112 or the one or more machine learning models on which the detector 112 is based are trained using only positive training examples, the detector 112 or the one or more machine learning models on which the detector 112 is based may not be highly accurate. For example, the detector 112 or the one or more machine learning models on which the detector 112 is based may predict that all or most noises are gunshot noises.

Examples from the second class may be negative training examples. If examples from both classes are included in the training data, the accuracy of the detector 112 or the one or more machine learning models on which the detector 112 is based may be improved. For example, if the detector 112 or the one or more machine learning models on which the detector 112 is based are being trained to detect whether a noise is a gunshot noise or not a gunshot noise, examples of noises that are not gunshot noises may be negative training examples. By training the detector 112 or the one or more machine learning models using both positive and negative training data, the detector 112 or the one or more machine learning models may be better able to detect which noises are gunshot noises, and which noises are not gunshot noises.

The training data database 104 may be implemented in the form of a network storage, such as, for example, a cloud-based storage accessible by other systems or devices via a network, such as the network 114. In addition to the training data 107, 108, the training data database 104 may store other information associated with the content assets or a service provider that maintains or operates the training data database 104.

The training data database 104 may comprise one or more computing devices and/or network devices. For example, the training data generator 110 and the content asset database 102 may comprise one or more networked servers. The training data database 104 may comprise a data storage device and/or system, such as a network-attached storage (NAS) system.

The training data generator 110 may implement one or more techniques described herein for generating training data in an unsupervised manner. For example, the training data generator 110 may receive, from the content asset database 104, one or more content assets 106. The content assets 106 may comprise video content. Video content may refer generally to any video content produced for viewer consumption regardless of the type, format, genre, or delivery method. Video content may comprise video content produced for broadcast via over-the-air radio, cable, satellite, or the internet. Video content may comprise digital video content produced for digital video streaming or video-on-demand. Video content may comprise a movie, a television show or program, an episodic or serial television series, or a documentary series, such as a nature documentary series. As yet another example, video content may include a regularly scheduled video program series, such as a nightly news program. The content assets 106 may be associated with one or more content distributors that distribute the content assets 106 to viewers for consumption.

The training data generator 110 may comprise one or more computing devices and/or network devices. For example, the training data generator 110 may comprise one or more networked servers. The training data generator 110 may comprise a data storage device and/or system, such as a network-attached storage (NAS) system.

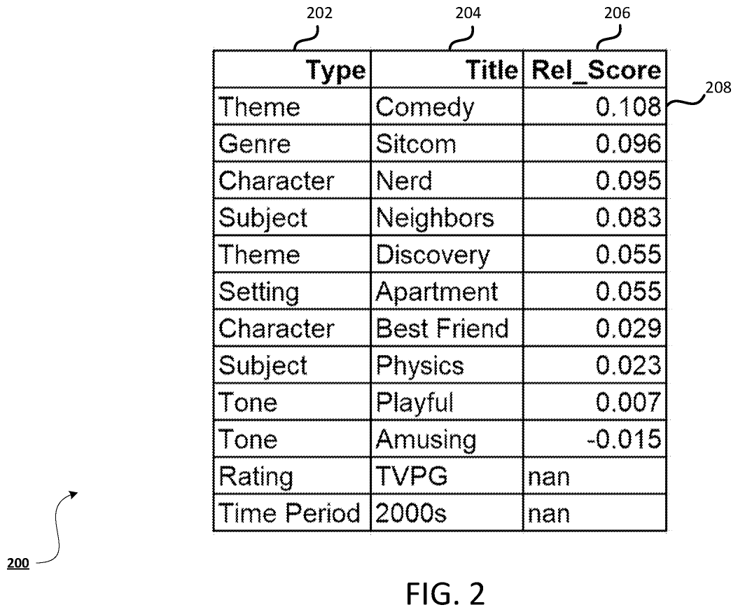

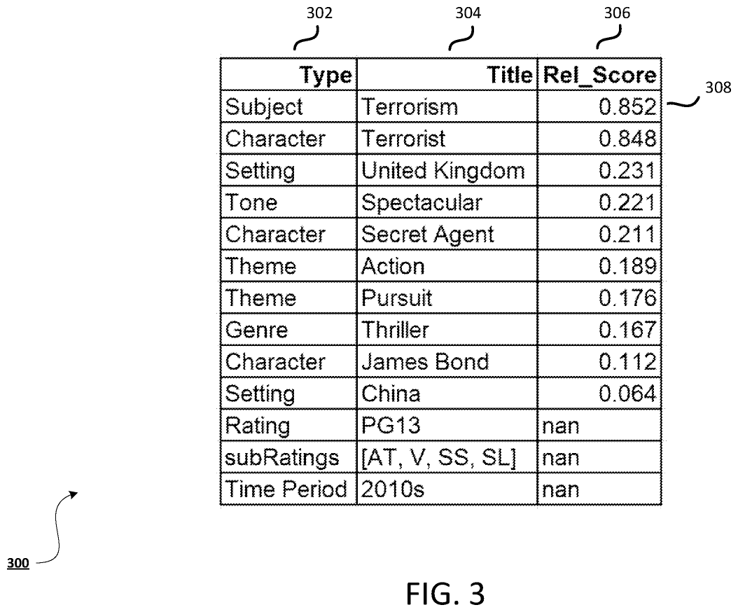

FIG. 2 illustrates an exemplary set of metadata 200 for a first content asset, such as a content asset 106 stored in the content asset database 104. FIG. 3 illustrates an exemplary set of metadata 300 for a second content asset, such as a different content asset 106 stored in the content asset database 104. The first and second content assets are each associated with a plurality of descriptive labels. While the first and second content assets of FIGS. 2-3 are each associated with twelve descriptive labels, other content assets may be associated with a greater number of descriptive labels or fewer descriptive labels.

Each descriptive label may comprise a type, such as the types found in columns 202, 302. The type of each descriptive label may indicate a type of content asset feature described by the label. For example, the type may be least one of “theme,” “subject,” “genre,” “rating,” or “time period.” Each descriptive label may also comprise a title, such as the titles found in columns 204, 304. The title of a descriptive label may be associated with the type of the descriptive label, and the title may describe the type it is associated with. For example, if a descriptive label associated with a content asset comprises the type “theme,” then the title associated with the type “theme” may be “comedy,” “discovery,” “action,” “pursuit,” or any other theme found within the content asset. As another example, if a descriptive label associated with a content asset comprises the type “character,” then the title associated with the type “character” may be “terrorist,” “secret agent,” “James Bond,” “nerd,” “best friend,” or any other character found within the content asset. As shown in FIGS. 2-3, the metadata associated with a content asset may comprise more than one descriptive label having the same type or may comprise only one descriptive label having the same type.

Each descriptive label from the plurality of descriptive labels may be associated with a relevance value, such as the relevance values found in columns 206, 306. The relevance value associated with a descriptive label may indicate how closely the descriptive label correlates with an object. The object may be an object that a party, such as a content distributor, wants to identify in different content assets. For example, the object may be a gunshot sound. A content distributor may want to identify content assets that contain a gunshot sound in order to be able to better recommend content for a particular consumer or to tailor content for a particular market in order to meet that market's compliance requirements. While the object may be a sound, the object may also be an audio event, a tangible item (i.e. a physical object, such as a car, chair, or tree), or a concept, such as violence.

The higher the relevance value for a descriptive label, the closer the correlation may be between the descriptive label and the object. For example, in FIG. 2, the first descriptive label comprising a type “theme” and a title “comedy” is associated with a relevance value 208 of 0.108. The second descriptive label comprising a type “genre” and a title “sitcom” is associated with a relevance value of 0.096. This may indicate that the first descriptive label of FIG. 2 correlates more closely with an object, such as a gunshot sound, than the second descriptive label of FIG. 2 does. As another example, in FIG. 3, the first descriptive label comprising a type “subject” and a title “terrorism” is associated with a relevance value 508 of 0.852. The second descriptive label comprising a type “character” and a title “terrorist” is associated with a relevance value 308 of 0.848. This may indicate that the first descriptive label of FIG. 3 correlates more closely with an object, such as a gunshot sound, than the second descriptive label of FIG. 3 does.

One or more descriptive labels in the plurality of labels may not be associated with a relevance value. For example, in FIG. 2, the last two descriptive labels in the set of metadata are not associated with a relevance value. Similarly, in FIG. 3, the last three descriptive labels in the set of metadata are not associated with a relevance value. A descriptive label not associated with a relevance value may be assigned a value “nan.”

The relevance value associated with one or more of the descriptive labels of the plurality of labels may not be included in the set of metadata. If the relevance value associated with one or more of the descriptive labels is not included in the set of metadata, the relevance value may be calculated. The relevance value associated with one or more of the descriptive labels may be calculated with respect to the object, such as a gunshot sound. To calculate the relevance value associated with one or more of the descriptive labels, a similarity, such as a semantic similarity, between the descriptive label “title(s)” and the object may be determined. The similarity between the descriptive label “title(s)” and the object may be determined, for example, using any known word embedding technique and/or any available semantic word similarity and/or relatedness measure.

The training data generator 110 may receive, from the detector 112, detector data. The detector 112 may be located external to the training data generator 110 or may be co-located with the training data generator 110. The detector 112 may generate the detector data. For example, the detector 112 may generate the detector data using a machine learning model. If the detector 112 generates the detector data using a machine learning model, the detector data may be, for example, output from the machine learning model. The detector data may comprise data identifying a portion of at least one content asset 106 as an instance of an object. As described above, the object may be an object that a party, such as a content distributor, wants to identify in different content assets. The object may be a sound, an audio event, a tangible item (i.e. a physical object, such as a car, chair, or tree), or a concept. For example, if the object is a gunshot sound, the detector data may comprise data identifying a portion of a content asset 106 as a gunshot sound. The portions identified by the detector 112 may be actual instances of the object or may instead be false identifications. For example, if the object is a gunshot sound, the portions of the content asset 106 identified by the detector 112 may be actual gunshot sounds or may be noises that sound similar to a gunshot sound, such as an explosion or a collision.

The training data generator 110 may generate negative training data using the received content assets 106 and the detector data. The training data generator 100 may determine a relevance score of at least one content asset 106. The relevance score of a content asset 106 may be determined based on the metadata associated with the content asset 106. The relevance score of the content asset 106 may indicate a likelihood of the content asset 106 comprising at least one instance of the object. The relevance score of a content asset 106 may be the highest relevance value associated with the plurality of descriptive metadata labels for that content asset 106. For example, the content asset associated with the exemplary set of metadata 200 of FIG. 2 may have a relevance score of 0.108 because 0.108 is the highest relevance value shown in column 206. Similarly, the content asset associated with the exemplary set of metadata 300 of FIG. 3 may have a relevance score of 0.852 because 0.852 is the highest relevance value shown in column 306.

The training data generator 110 may compare the relevance score to a threshold value to determine if the identified portion of at least one content asset 106 is a false identification of the object. The threshold value may be a predetermined value. For example, the threshold value may be equal to 0.5, 0.4, 0.3, 0.2, 0.1, or any number less than one. The identified portion of the content asset 106 is more likely to be a false identification of the object if there is a low likelihood of the content asset 106 comprising an instance of the object. Accordingly, a lower relevance score for a content asset 106 is indicative of a higher likelihood that the identified portion of the content asset 106 is a false identification. Conversely, a higher relevance score for a content asset 106 is indicative of a lower likelihood that the identified portion of the content asset 106 is a false identification.

If the relevance score of the content asset 106 does not exceed the threshold value the identified portion of the content asset 106 may be a false identification of the object. For example, if the content asset associated with the exemplary set of metadata 200 of FIG. 2 has a relevance score of 0.108 and the threshold value is 0.3, the relevance score of the content asset does not exceed the threshold value. As another example, if the content asset associated with the exemplary set of metadata 300 of FIG. 3, has a relevance score of 0.852 and the threshold value is 0.3, the relevance score of the content asset exceeds the threshold value.

If the relevance score for the content asset 106 does not exceed the threshold value the identified portion of the content asset 106 may be labeled as a false identification of the object because there is a low likelihood of the content asset 106 comprising an instance of the object. If the portion of the content asset is a false identification of the object, the portion of the content asset may be labeled as a false identification and may be used as negative training data for a machine learning model. The training data generator 110 may send this negative training data to a computing device for storage, by the computing device, in the training data database 104. The negative training data may be stored in the training data database 104 as negative training data 108. Other training data may already be stored in the training data database 104. For example, positive training data 107 and existing negative training data 108 may already be stored in the training data database 104. A machine learning model, such as a machine learning model of the detector 112, may be trained using the positive training data 107 and the negative training data 108 stored in the training data database 104.

If the relevance score of the content asset 106 exceeds the threshold value, the identified portion of the content asset 106 may not be a false identification of the object because there is not a low likelihood of the content asset 106 comprising an instance of the object. If the portion of the content asset 106 is not a false identification of the object, the portion of the content asset 106 may not be labeled as a false identification of the object or used as negative training data for the machine learning model.

As noted, the content asset database 102, training data database 104, training data generator 110, and detector 112 may each be implemented in one or more computing devices. Such a computing device may comprise one or more processors and memory storing instructions that, when executed by the one or more processors, cause the computing device to perform one or more of the various methods or techniques described here. The memory may comprise volatile memory (e.g., random access memory (RAM)) and/or non-volatile memory (e.g., a hard or solid-state drive). The memory may comprise a non-transitory computer-readable medium. The computing device may comprise one or more input devices, such as a mouse, a keyboard, or a touch interface. The computing device may comprise one or more output devices, such as a monitor or other video display. The computing device may comprise an audio input and/or output. The computing device may comprise one or more network communication interfaces, such as a wireless transceiver (e.g., Wi-Fi or cellular) or wired network interface (e.g., ethernet). The one or more network communication interfaces may be configured to connect to the network 114.

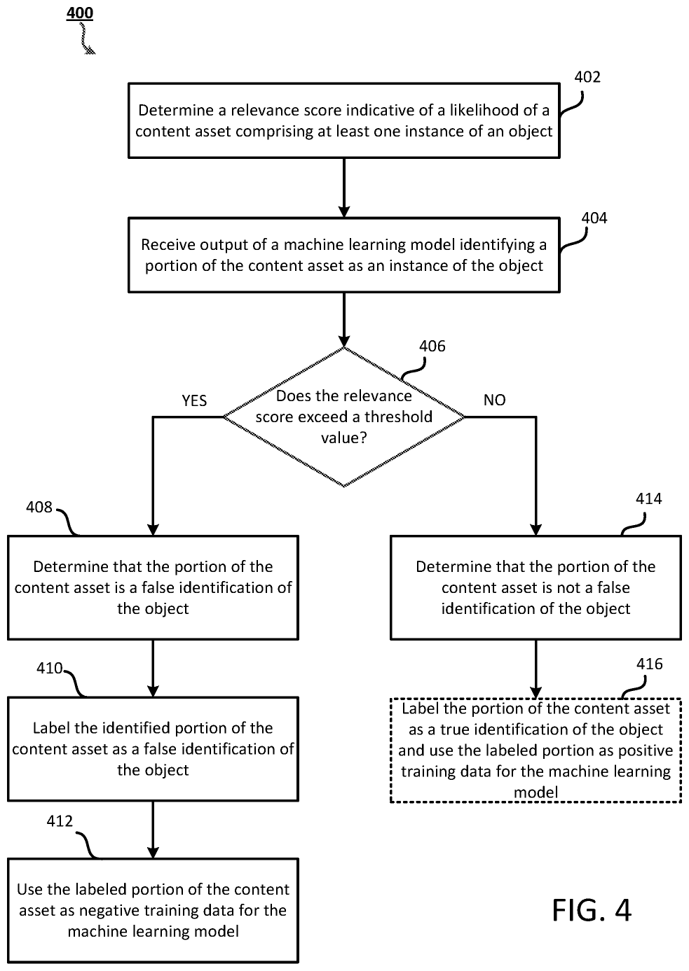

FIG. 4 shows an example method 400. The method 400 may be used to generate training data. The method 400 may be used to generate negative training data. The method 400 may be performed, for example, by the training data generator 110 of FIG. 1. The method 400 may be performed by another component of the system 100 of FIG. 1. The method 400 may be used to generate negative training data for a machine learning model. The method 400 may generate negative training data in an unsupervised manner, i.e., automatically. Once generated, the negative training data may be used along with existing training data to train a machine learning model of a multimedia detector to detect an object of interest in content assets, such as the content assets 106. The object of interest may be an object that a party, such as a content distributor, wants to identify in content assets. The object may be a sound, audio event, tangible object, or concept. For example, a content distributor may want to identify gunshot sounds in content assets.

The negative training data may be extracted from existing content assets, such as content assets that belong to a content distributor. The content assets that are good candidates from which to extract negative training data may be the content assets that are not likely to contain an instance of the object of interest. For example, if the object of interest is a gunshot sound, content assets that are good candidates from which to extract negative training data may include comedy or family friendly television shows and movies because these content assets are not likely to contain a gunshot sound. To identify whether a particular content asset is a good candidate from which to extract negative training data, a relevance score may be determined for the content asset.

In step 402, a relevance score indicative of a likelihood of a content asset comprising at least one instance of an object may be determined. The relevance score may be determined using metadata associated with the content asset, such as the exemplary set of metadata 200 of FIG. 2 or the exemplary set of metadata 300 of FIG. 3. As discussed above, the metadata associated with a content asset may list a plurality of descriptive labels associated with the content asset. Each descriptive label may comprise a type that indicates a type of the metadata label and a title that may describe the type it is associated with. For example, a descriptive label associated with a content asset may comprise the type “character” and the title “terrorist,” “secret agent,” “James Bond,” “nerd,” “best friend,” or any other character found within the content asset. As also described above, each descriptive label may be associated with a relevance value, such as the relevance values found in columns 206, 306 of FIGS. 2-3. The relevance value associated with a descriptive label may indicate how closely the descriptive label correlates with the object. The higher the relevance value for a descriptive label, the closer the correlation may be between the descriptive label and the object.

The relevance values, such as the relevance values found in columns 206, 306, associated with the plurality of descriptive metadata labels, may be used to generate the relevance score. The relevance score associated with the content asset may be the highest relevance value associated with any of the plurality of descriptive metadata labels. For example, the content asset associated with the exemplary set of metadata 200 of FIG. 2 may have a relevance score of 0.108 because 0.108 is the highest relevance value shown in column 206. Similarly, the content asset associated with the exemplary set of metadata 300 of FIG. 3 may have a relevance score of 0.852 because 0.852 is the highest relevance value shown in column 306. The relevance score may alternatively be an average, or a weighted average, of the relevance values associated with the plurality of descriptive metadata labels.

The higher the relevance score, the greater the likelihood of the content asset comprising at least one instance of the object. For example, if the object is a gunshot sound, a war movie may have significantly higher relevance score than a children's movie, because a war movie is likely to contain a gunshot sound whereas a children's movie is not likely to contain a gunshot sound. Accordingly, content assets with lower relevance scores may be better candidates from which to extract the negative training data.

As discussed above, some descriptive labels from the plurality of descriptive labels may not be associated with a relevance value. Such descriptive labels not associated with a relevance value may be assigned a value “nan.” These descriptive labels may still be considered when determining the relevance score for a content asset. The descriptive labels not associated with a relevance value may be considered in addition to or instead of the other labels from the plurality of descriptive metadata labels. Whether a descriptive label not associated with a relevance value is considered when determining the relevance score for the content asset may depend on the object of interest. If the descriptive label not associated with a relevance value is likely to provide insight into whether the content asset comprises an instance of the object, then the descriptive label not associated with a relevance value may be considered when determining the relevance score for the content asset may depend on the object. For example, referring to FIGS. 2-3, if the object is a gunshot noise, the descriptive labels titled “Rating” and “subRating” may be considered when determining the relevance score for the content asset even though they are not associated with a relevance value. This is because the rating or subrating of a content asset is likely to provide insight into whether the content asset comprises an instance of a gunshot noise. For example, a movie rated PG is less likely to contain an instance of a gunshot noise than a movie that is rated R.

If the descriptive label not associated with a relevance value is unlikely to provide insight into whether the content asset comprises an instance of the object, then the descriptive label not associated with a relevance value may be ignored when determining the relevance score for the content asset. For example, if the object is a landmark, such as the Eiffel Tower, the descriptive labels titled “Rating” and “subRating” likely provide little insight into whether the content asset comprises an instance of the landmark and may not be considered when determining the relevance score for the content asset.

The content asset may be input to a detector, such as the detector 112, and the detector may be used to identify any portion of the content asset that is an instance of the object. The detector may use a machine learning model to identify the portions of the content asset as instances of the object. For example, if the object is a gunshot sound, the detector may be run on the content asset to identify any portion of the content asset that sounds like a gunshot sound. The portions identified by the detector may be actual instances of gunshot sounds or may instead be false identifications—noises that sound similar to a gunshot sound, such as an explosion or a collision. As discussed above, false identifications are more likely to occur in content assets having a low relevance score. In step 404, data identifying a portion of the content asset as an instance of the object may be received. For example, the data identifying the portion of the content asset as an instance of the object may be the output of a machine learning model.

To determine whether the portions identified by the detector are actual instances of the object or false identifications, the relevance score of the content asset may be compared to a threshold value. The identified portion of the content asset is more likely to be a false identification if there is a low likelihood of the content asset comprising an instance of the object. Accordingly, a lower relevance score for a content asset is indicative of a higher likelihood that the identified portion of the content asset is a false identification. Conversely, a higher relevance score for a content asset is indicative of a lower likelihood that the identified portion of the content asset is a false identification.

In step 406, it may be determined whether the relevance score of the content asset exceeds a threshold value. The threshold value may be a predetermined value. For example, the threshold value may be equal to 0.5, 0.4, 0.3, 0.2, 0.1, or any number less than one. For example, if the content asset associated with the exemplary set of metadata 200 of FIG. 2 has a relevance score of 0.108 and the threshold value is 0.3, the relevance score of the content asset does not exceed the threshold value. As another example, if the content asset associated with the exemplary set of metadata 300 of FIG. 3, has a relevance score of 0.852 and the threshold value is 0.3, the relevance score of the content asset exceeds the threshold value.

If the relevance score does not exceed the threshold value, such as the relevance score associated with the content asset associated with the exemplary set of metadata 200 of FIG. 2, the identified portion of the content asset may be a false identification of the object because there is a low likelihood of the content asset comprising an instance of the object. The method 400 may proceed to step 408. In step 408, it may be determined that the portion of the content asset is a false identification of the object. For example, it may be determined that the relevance score does not exceed the threshold value. It it is determined that the portion of the content asset is a false identification of the object, there may be a low likelihood of the content asset comprising an instance of the object.

In step 410, the identified portion of the content asset may be labeled as a false identification of the object. If the identified portion of the content asset is a false identification of the object, then it may be stored in a database, such as the training data database 104, as negative training data, such as negative training data 108. The database may already contain other training data, such as existing negative training data or existing positive training data. The labeled portion of the content asset may be sent to a computing device for storage, by the computing device, in a database comprising training data for a machine learning model.

In step 412, the labeled portion of the content asset may be used as negative training data for the machine learning model. The labeled portion of the content asset may be used, along with any other training data stored in the database, to train a machine learning model to detect the object. By adding the labeled portion of the content asset to the negative training data set, the accuracy of the machine learning model may be improved. Over time, as the training data set continues to be augmented, the accuracy of the machine learning model may continue to improve. If it is determined in step 406 that the relevance score of the content asset exceeds the threshold value, such as the relevance score associated with the content asset associated with the exemplary set of metadata 300 of FIG. 3, the identified portion of the content asset may not be a false identification of the object because there is not a low likelihood of the content asset comprising an instance of the object. The method 400 may proceed to step 414. In step 414, it may be determined that the identified portion of the content asset is not a false identification of the object. If the portion of the content asset is not a false identification of the object, the portion of the content asset may not be labeled as a false identification of the object or used as negative training data for the machine learning model.

Optionally, in step 416, if it is determined that the identified portion of the content asset is not a false identification of the object, the identified portion of the content asset may be labeled as a true identification of the object and may be stored in a database, such as the training data database 104, as positive training data 107. The database may already contain other training data, such as existing negative training data or existing positive training data. The labeled portion of the content asset may be sent to a computing device for storage, by the computing device, in a database comprising training data for a machine learning model. The labeled portion of the content asset may be used as positive training data for the machine learning model. The labeled portion of the content asset may be used, along with any other training data stored in the database, to train a machine learning model to detect the object.

The negative training data obtained via the method 400 may be particularly useful negative training data because, despite being false identifications of the object of interest, they resemble (e.g. in sound and/or appearance) the object of interest from the perspective of a detector, such as the detector 112. Conversely, less useful (e.g. less informative) negative training data may be, for example, a random example of an object that does not resemble (e.g. in sound and/or appearance) the object of interest. For example, training and/or re-training a gunshot sound detector using “laughing” truth data as negative training data will result in a less accurate gunshot sound detector than a gunshot sound detector that has been trained and/or re-trained using the negative training data obtained via the method 400. Therefore, incorporating the negative training data obtained via the method 400 in the training and/or re-training process of a detector, such as the detector 112, the accuracy of the detector may be improved.

While the method 400 may be used to identify portions of content assets that may be used as training data for a machine learning model, the method 400 or aspects of the method 400 may additionally, or alternatively, be used for other purposes. For example, the method 400 may be used to identify a particular type of program, such as a violent movie or television show. To determine whether a particular program contains an object, such as an instance of a gunshot sound, a detector may be run to identify the object in the program. If the detector does detect an instance of the object, the relevance score described above with reference to method 400 may be used to determine whether or not that the detector identified a false identification of the object. If the instance of the object is a false identification, that program may not be included in search results for that particular type of program, such as “violent” programs. Alternatively, if the detector did not identify a false identification of the object, that program may be included in search results for that particular type of program, such as “violent” programs.

While the techniques described herein may be used to label an identified portion of a content asset as a false identification of any object, certain objects may be better candidates than others. For example, objects that are good candidates may be those that are likely to be featured in a subset of content assets but unlikely to be featured in another subset of content assets.

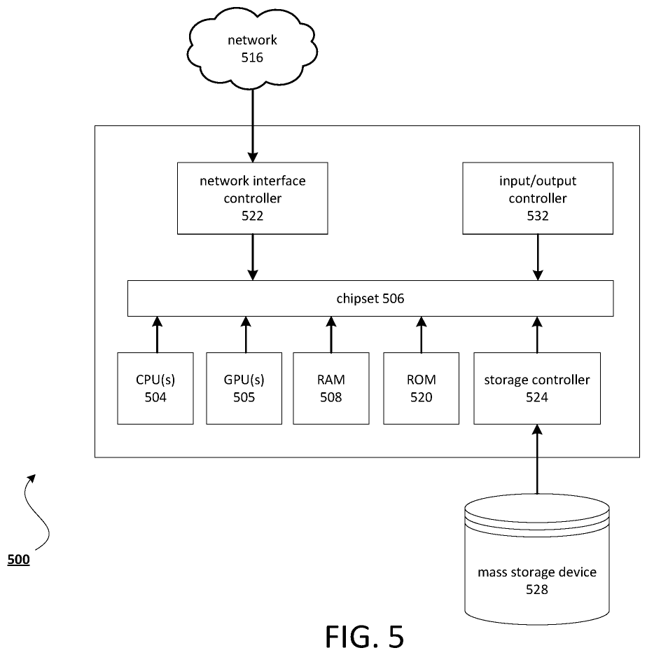

FIG. 5 depicts an example computing device 500 that may be used to implement any of the various devices or entities illustrated in FIG. 1, including, for example, the content asset database 102, the training data database 104, the training data generator 110, and the detector 112. That is, the computing device 500 shown in FIG. 5 may be any smartphone, server computer, workstation, access point, router, gateway, tablet computer, laptop computer, notebook computer, desktop computer, personal computer, network appliance, PDA, e-reader, user equipment (UE), mobile station, fixed or mobile subscriber unit, pager, wireless sensor, consumer electronics, or other computing device, and may be utilized to execute any aspects of the methods and apparatus described herein, such as to implement any of the apparatus of FIG. 1 or the methods described in relation to FIG. 4.

The computing device 500 may include a baseboard, or “motherboard,” which is a printed circuit board to which a multitude of components or devices may be connected by way of a system bus or other electrical communication paths. One or more central processing units (CPUs or “processors”) 504 may operate in conjunction with a chipset 506. The CPU(s) 504 may be standard programmable processors that perform arithmetic and logical operations necessary for the operation of the computing device 500.

The CPU(s) 504 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 504 may be augmented with or replaced by other processing units, such as GPU(s) 505. The GPU(s) 505 may comprise processing units specialized for but not necessarily limited to highly parallel computations, such as graphics and other visualization-related processing.

A chipset 506 may provide an interface between the CPU(s) 504 and the remainder of the components and devices on the baseboard. The chipset 506 may provide an interface to a random access memory (RAM) 508 used as the main memory in the computing device 500. The chipset 506 may provide an interface to a computer-readable storage medium, such as a read-only memory (ROM) 520 or non-volatile RAM (NVRAM) (not shown), for storing basic routines that may help to start up the computing device 500 and to transfer information between the various components and devices. ROM 520 or NVRAM may also store other software components necessary for the operation of the computing device 500 in accordance with the aspects described herein.

The computing device 500 may operate in a networked environment using logical connections to remote computing nodes and computer systems of the communications network 100. The chipset 506 may include functionality for providing network connectivity through a network interface controller (NIC) 522. A NIC 522 may be capable of connecting the computing device 500 to other computing nodes over the communications network 100. It should be appreciated that multiple NICs 522 may be present in the computing device 500, connecting the computing device to other types of networks and remote computer systems. The NIC may be configured to implement a wired local area network technology, such as IEEE 802.3 (“Ethernet”) or the like. The NIC may also comprise any suitable wireless network interface controller capable of wirelessly connecting and communicating with other devices or computing nodes on the communications network 100. For example, the NIC 522 may operate in accordance with any of a variety of wireless communication protocols, including for example, the IEEE 802.11 (“Wi-Fi”) protocol, the IEEE 802.16 or 802.20 (“WiMAX”) protocols, the IEEE 802.15.4a (“Zigbee”) protocol, the 802.15.3c (“UWB”) protocol, or the like.

The computing device 500 may be connected to a mass storage device 528 that provides non-volatile storage (i.e., memory) for the computer. The mass storage device 528 may store system programs, application programs, other program modules, and data, which have been described in greater detail herein. The mass storage device 528 may be connected to the computing device 500 through a storage controller 524 connected to the chipset 506. The mass storage device 528 may consist of one or more physical storage units. A storage controller 524 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 500 may store data on a mass storage device 528 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 528 is characterized as primary or secondary storage and the like.

For example, the computing device 500 may store information to the mass storage device 528 by issuing instructions through a storage controller 524 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 500 may read information from the mass storage device 528 by detecting the physical states or characteristics of one or more particular locations within the physical storage units.

In addition to the mass storage device 528 described herein, the computing device 500 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 500.

By way of example and not limitation, computer-readable storage media may include volatile and non-volatile, non-transitory computer-readable storage media, and removable and non-removable media implemented in any method or technology. However, as used herein, the term computer-readable storage media does not encompass transitory computer-readable storage media, such as signals. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other non-transitory medium that may be used to store the desired information in a non-transitory fashion.

A mass storage device, such as the mass storage device 528 depicted in FIG. 5, may store an operating system utilized to control the operation of the computing device 500. The operating system may comprise a version of the LINUX operating system. The operating system may comprise a version of the WINDOWS SERVER operating system from the MICROSOFT Corporation. According to additional aspects, the operating system may comprise a version of the UNIX operating system. Various mobile phone operating systems, such as IOS and ANDROID, may also be utilized. It should be appreciated that other operating systems may also be utilized. The mass storage device 528 may store other system or application programs and data utilized by the computing device 500.

The mass storage device 528 or other computer-readable storage media may also be encoded with computer-executable instructions, which, when loaded into the computing device 500, transforms the computing device from a general-purpose computing system into a special-purpose computer capable of implementing the aspects described herein. These computer-executable instructions transform the computing device 500 by specifying how the CPU(s) 504 transition between states, as described herein. The computing device 500 may have access to computer-readable storage media storing computer-executable instructions, which, when executed by the computing device 500, may perform the methods described in relation to FIG. 4.

A computing device, such as the computing device 500 depicted in FIG. 5, may also include an input/output controller 532 for receiving and processing input from a number of input devices, such as a keyboard, a mouse, a touchpad, a touch screen, an electronic stylus, or other type of input device. Similarly, an input/output controller 532 may provide output to a display, such as a computer monitor, a flat-panel display, a digital projector, a printer, a plotter, or other type of output device. It will be appreciated that the computing device 500 may not include all of the components shown in FIG. 5, may include other components that are not explicitly shown in FIG. 5, or may utilize an architecture completely different than that shown in FIG. 5.

As described herein, a computing device may be a physical computing device, such as the computing device 500 of FIG. 5. A computing device may also include a virtual machine host process and one or more virtual machine instances. Computer-executable instructions may be executed by the physical hardware of a computing device indirectly through interpretation and/or execution of instructions stored and executed in the context of a virtual machine.

One skilled in the art will appreciate that the systems and methods disclosed herein may be implemented via a computing device that may comprise, but are not limited to, one or more processors, a system memory, and a system bus that couples various system components including the processor to the system memory. In the case of multiple processors, the system may utilize parallel computing.

For purposes of illustration, application programs and other executable program components such as the operating system are illustrated herein as discrete blocks, although it is recognized that such programs and components reside at various times in different storage components of the computing device, and are executed by the data processor(s) of the computer. An implementation of service software may be stored on or transmitted across some form of computer-readable media. Any of the disclosed methods may be performed by computer-readable instructions embodied on computer-readable media. Computer-readable media may be any available media that may be accessed by a computer. By way of example and not meant to be limiting, computer-readable media may comprise “computer storage media” and “communications media.” “Computer storage media” comprise volatile and non-volatile, removable and non-removable media implemented in any methods or technology for storage of information such as computer-readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by a computer. Application programs and the like and/or storage media may be implemented, at least in part, at a remote system.

As used in the specification and the appended claims, the singular forms “a,” “an” and “the” include plural referents unless the context clearly dictates otherwise. Ranges may be expressed herein as from “about” one particular value, and/or to “about” another particular value. Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect.

It will be apparent to those skilled in the art that various modifications and variations may be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A method comprising:
determining, based on metadata associated with a content asset, a relevance score indicative of a likelihood of the content asset comprising at least one instance of an object;
receiving data identifying a detected portion of the content asset comprising an instance of the object; and
based on the relevance score not exceeding a threshold value, determining that the detected portion of the content asset is not an instance of the object.

2. The method recited in claim 1, wherein the determining that the detected portion of the content asset is not an instance of the object further comprises labeling the detected portion of the content asset as a false identification of the object.

3. The method recited in claim 2, wherein the data comprises an output of a machine learning model trained to detect instances of the object, and wherein the method further comprises using the labeled portion of the content asset as negative training data for the machine learning model.

4. The method recited in claim 1, wherein the content asset comprises at least one of a video program, an audio program, a movie, a television show, or a video-on-demand asset.

5. The method recited in claim 1, wherein the object comprises at least one of a sound, an audio event, a tangible item, or a concept.

6. The method recited in claim 1, wherein the metadata associated with the content asset comprises a plurality of labels associated with the content asset, wherein each of the plurality of labels is associated with a relevance value indicative of a correlation between the label and the object.

7. The method recited in claim 1, wherein the relevance score is equal to the relevance value associated with the label, of the plurality of labels, having the highest correlation with the object.

8. The method recited in claim 1, wherein the threshold is a value indicative of a predetermined level of relevance associated with the object.

9. A method comprising:
determining, based on metadata associated with a first content asset, a first relevance score indicative of a likelihood of the first content asset comprising at least one instance of an object;
receiving output of a machine learning model identifying a portion of the first content asset as an instance of the object; and
based on the first relevance score not exceeding a threshold value, determining the portion of the first content asset to be a false identification of the object.

10. The method recited in claim 9, further comprising using the portion of the first content asset as negative training data for the machine learning model.

11. The method recited in claim 9, further comprising:
determining, based on metadata associated with a second content asset, a second relevance score indicative of a likelihood of the second content asset comprising at least one instance of the object;
receiving output of a machine learning model identifying a portion of the second content asset as an instance of the object; and
based on the second relevance score exceeding the threshold value, determining that the portion of the second content asset is not a false identification of the object.

12. The method recited in claim 9, wherein the object comprises at least one of a sound, an audio event, a tangible item, or a concept.

13. The method recited in claim 9, wherein the metadata associated with the first content asset comprises a plurality of labels associated with the first content asset, and wherein each of the plurality of labels is associated with a relevance value indicative of a correlation between the label and the object.

14. The method recited in claim 13, wherein the first relevance score is equal to the relevance value associated with the label, of the plurality of labels, having the highest correlation with the object.

15. The method recited in claim 13, wherein the plurality of labels associated with the first content asset comprise at least one of a theme, a subject, a genre, a setting, a character, a tone, a rating, or a time period associated with the first content asset.

16. A method comprising:
determining, for each of a plurality of metadata labels associated with a content asset, a relevance value indicative of a correlation between the metadata label and an object;
determining, based on the plurality of relevance values, a relevance score indicative of a likelihood of the content asset comprising at least one instance of an object;
determining that the relevance score does not exceed a threshold;
detecting at least one instance of the object in the content asset; and
labeling the at least one instance of the object as a false identification of the object.

17. The method recited in claim 16, further comprising using the labeled instance of the object as negative training data for a machine learning model.

18. The method recited in claim 16, further comprising sending the labeled instance of the object to a computing device for storage, by the computing device, in a database comprising training data for a machine learning model.

19. The method recited in claim 16, wherein determining, based on the plurality of relevance values, the relevance score indicative of the likelihood of the content asset comprising at least one instance of an object comprises:
identifying a relevance value from the plurality of relevance values having the greatest value; and
assigning the relevance score a value equal to the relevance value.

20. The method recited in claim 16, wherein detecting the at least one instance of the object in the content asset comprises using a machine learning model to detect the at least one instance of the object in the content asset.
